(19) United States
(12) Patent Application Publication
(10) Pub. No.: US 2020/0343595 A1
(43) Pub. Date: Oct. 29, 2020

(54) RECHARGEABLE BATTERY

(71) Applicant: NANJING WEISU TECHNOLOGY LTD., Nanjing Jiangsu (CN)

(72) Inventors: Xiaolin LIU, Nanjing Jiangsu (CN); Jianjun SHU, Nanjing Jiangsu (CN)

(21) Appl. No.: 16/757,057

(22) PCT Filed: Sep. 27, 2018
(86) PCT No.: PCT/CN2018/107834

§ 371 Date: Apr. 17, 2020

(30) Foreign Application Priority Data
Oct. 20, 2017 (CN) 201710984090.6
Jul. 26, 2018 (CN) 201810835244.X

(51) Int. Cl. H01M 10/38; H01M 4/50; H01M 4/38

(52) U.S. Cl. CPC H01M 10/38; H01M 4/50; H01M 2004/027; H01M 2300/002; H01M 4/38

(57) ABSTRACT

The present invention provides a rechargeable battery including an electrolyte, a positive electrode, a negative electrode, an isolation membrane arranged between the positive electrode and the negative electrode, an active substance of said positive electrode including one or more of manganese oxide and manganese oxyhydroxide an active substance of said negative electrode including zinc and electrolyte salts in said electrolyte contain one or more of zinc alkylsulfonate, zinc arylsulfonate, zinc fluoroborate, zinc alkylsulfate hydrate, zinc arylsulfonate hydrate and zinc fluoroborate hydrate. The rechargeable battery, according to the present invention, will not only effectively avoid the irreversible sulfation of the positive electrode, improve the reversibility of the positive electrode, significantly prolong the cycle life of the rechargeable battery and achieve a higher energy density as well, but also avert problems of chloride ions corrosion and frequent nitrate ions reduction. Compared with the lithium battery on the market, the rechargeable battery according to the present invention uses low-cost materials, and therefore has better economic benefits.

### FIELD OF THE INVENTION

The invention relates to chemical power supplies and more particularly to a rechargeable battery.

### BACKGROUND OF THE INVENTION

Rechargeable zinc-manganese battery is a green and environmentally friendly chemical power supply, which uses manganese oxide as the active material for the positive electrode and zinc as the active material for the negative electrode. The electrolyte of rechargeable zinc-manganese battery can be divided into two categories: one is alkaline system, but the polarization of the rechargeable zinc-manganese battery is very large and the circulation stability is very poor in an alkaline electrolyte; the other is a neutral or weakly acidic system, such as zinc sulfate solution. In the 1990s, the rechargeable zinc-manganese battery achieved more than 50 times of deep charge-discharge cycles by modifying the positive electrode material and using a dendritic-resistant isolation membrane. At the same time, due to its good rate performance, high and low temperature performance and the low price of the selected materials, the rechargeable zinc-manganese battery once almost achieved commercial production. Its charge-discharge mechanism is represented by the reaction below:

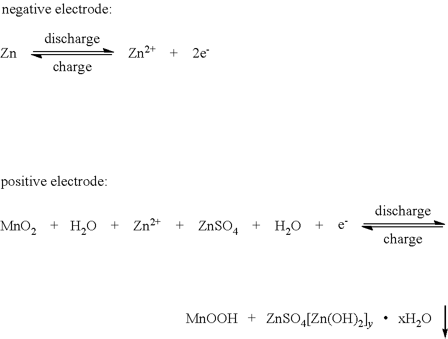

From the above reaction, it can be seen that during the discharge of this battery, zinc ions are not embedded in the manganese dioxide crystal lattice, but combine with the SO₄²⁻anion in the electrolyte to form a precipitate. This precipitate is not easily decomposed during the charging process, which greatly reduces the reversibility of the positive electrode and seriously affects the circulation stability of the rechargeable zinc-manganese battery. What's worse, after cycling for many times, ZnSO₄[Zn(OH)₂]₃xH₂O will be wrapped on the surface of the positive electrode material, hindering ions from transmitting in the electrolyte and seriously affecting the capacity and cycle life of the battery. Although there are several methods to improve the reversibility of the positive electrode, the effect is still limited and the circulation stability of the battery cannot meet the minimum requirements of commercial production.

### SUMMARY OF THE INVENTION

The object of the present invention is to overcome the deficiencies of the prior art and provide a rechargeable battery.

A rechargeable battery includes a case, an electrolyte, a positive electrode, a negative electrode and an isolation membrane arranged between the positive electrode and the negative electrode; said positive and negative electrode are provided in the electrolyte; said electrolyte, said positive electrode, said negative electrode and said isolation membrane are all provided in the case; an active substance of said positive electrode includes one or more of manganese oxide and manganese oxyhydroxide; an active substance of said negative electrode includes zinc; electrolyte salts in said electrolyte contain one or more of zinc alkylsulfonate, zinc arylsulfonate, zinc fluoroborate, zinc alkylsulfate hydrate, zinc arylsulfonate hydrate and zinc fluoroborate hydrate.

The concentration of the electrolyte salt in said electrolyte is 0.1˜8 mol/L.

The molar percentage of an electrolyte salt containing one or more of sulfonate ions and fluoroborate ions in said electrolyte salt is 5% or more of total electrolyte salt, preferably 45% or more, more preferably 55% or more.

The concentration of zinc ion in said electrolyte is 0.1˜6 mol/L, preferably 1.0˜2.5 mol/L.

Said electrolyte salt containing sulfonate ion includes one or more of zinc alkylsulfonate, zinc arylsulfonate, zinc alkylsulfonate hydrate, zinc arylsulfonate hydrate, manganese alkylsulfonate, manganese arylsulfonate, manganese alkylsulfonate hydrate and manganese arylsulfonate hydrate.

Said electrolyte salt containing fluoroborate ions includes one or more of zinc fluoroborate, manganese fluoroborate, zinc fluoroborate hydrate and manganese fluoroborate hydrate.

Said zinc alkylsulfonate includes one or more of zinc methanesulfonate, zinc ethylsulfonate and zinc propylsulfonate.

Said zinc arylsulfonate includes one or more of zinc benzenesulfonate and zinc p-toluenesulfonate.

Said zinc alkylsulfonate hydrate includes one or more of zinc methanesulfonate hydrate, zinc ethylsulfonate hydrate and zinc propylsulfonate hydrate.

Said zinc arylsulfonate hydrate includes one or more of zinc benzenesulfonate hydrate and zinc p-toluenesulfonate hydrate.

The electrolyte salt in said electrolyte further includes one or more of manganese alkylsulfonate, manganese arylsulfonate, manganese fluoroborate, manganese alkylsulfonate hydrate, manganese arylsulfonate hydrate and manganese fluoroborate hydrate.

Said manganese alkylsulfonate includes one or more of manganese methanesulfonate, manganese ethylsulfonate and manganese propylsulfonate. Said manganese arylsulfonate is one or more of manganese benzenesulfonate and manganese p-toluenesulfonate. Said manganese alkylsulfonate hydrate includes one or more of manganese methanesulfonate hydrate, manganese ethylsulfonate hydrate and manganese propylsulfonate hydrate. Said manganese arylsulfonate hydrate includes one or more of manganese benzenesulfonate hydrate and manganese p-toluenesulfonate hydrate.

The mass percentage of one or more of manganese oxide and manganese oxyhydroxide is 20% or more of the active substance of said positive electrode, preferably 45% or more, more preferably 55% or more. The crystal lattice of the manganese oxide or manganese oxyhydroxide may also contain a small amount of other impurity ions, but it is still dominated by manganese and oxygen. The number of manganese ions is more than 80% of all cations and the sum of the number of oxygen ions and hydroxide ions is more than 80% of all anions.

The manganese oxide and manganese oxyhydroxide in the active substance of said positive electrode may exist in the form of a hydrate.

The mass percentage of zinc is 33% or more of the active substance of said negative electrode, preferably 45% or more, more preferably 55% or more. Zinc may exist in the form of zinc foil, zinc flakes, zinc powder (the zinc powder is mixed with an adhesive to make a solid material as a negative electrode) and zinc alloy.

The solvent of said electrolyte is water or a mixture of water and an organic solvent.

The organic solvent includes one or more of an ether organic solvent, an ester organic solvent, a nitrile organic solvent, an amine organic solvent, a sulfone organic solvent, an alcohol organic solvent and an amide organic solvent.

The electrolyte salt may further include one or more of zinc sulfate, manganese sulfate, zinc chloride, manganese chloride, zinc nitrate, manganese nitrate, zinc acetate, manganese acetate, zinc formate and the manganese formate, which substantially do not affect the capacity and circulation stability of the battery.

Taking the zinc methanesulfonate containing sulfonate ions in the electrolyte as an example, the reaction equation of the charge-discharge mechanism of the rechargeable zinc-manganese battery described in the present invention is represented below:

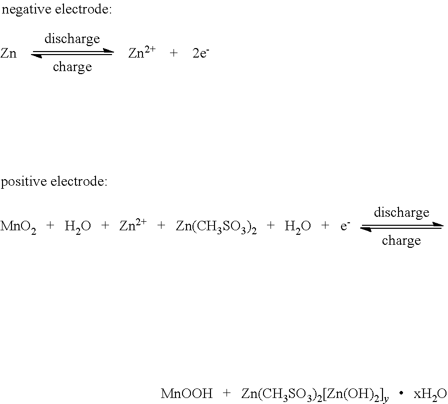

From the above reaction, it can be seen that, because methanesulfonate is a monovalent anion and sulfate is a divalent anion and from the perspective of volume effect, methanesulfonate has one more methyl group than sulfate and a larger volume, the negative charge of the methanesulfonate anion is more dispersed, which makes the attraction to the cations (Zn²⁺) more weakly. During the charging process, Zn(CH₃SO₃)₂[Zn(OH)₂]₃.xH₂O is more easily decomposed, so that using methanesulfonate as an electrolyte salt can boost the reversibility of the positive electrode of rechargeable zinc-manganese batteries and improve the capacity and circulation life of the rechargeable battery, while using sulfate as the electrolyte salt of the battery system will cause irreversible sulfation of the positive electrode and greatly reduce the reversibility of the positive electrode. In the same way, the charge-discharge reaction mechanism of the rechargeable battery of the present invention applies to the electrolyte containing fluoroborate ion.

The hydrogen atoms in said zinc methanesulfonate, zinc ethylsulfonate, zinc propylsulfonate, manganese methanesulfonate, manganese ethylsulfonate, manganese propylsulfonate, zinc benzenesulfonate, zinc p-toluenesulfonate, manganese besylate, manganese p-toluenesulfonate and their hydrates can also be substituted by other substituents. The other substituents may specifically be one or more of a fluorine atom, a chlorine atom, a methyl group, an ethyl group, an n-propyl group, an isopropyl group and a hydroxide group.

Due to the above technical scheme, the present invention has the following beneficial effects:

1. The zinc salt (zinc alkylsulfonate, zinc arylsulfonate, zinc fluoborate) and its hydrate, manganese salt (manganese alkylsulfonate, manganese arylsulfonate, manganese fluoroborate) and its hydrates that are used in the rechargeable battery according to the present invention will not only improve the reversibility of the positive electrode, effectively avoid the irreversible sulfation of the positive electrode, significantly prolong the cycle life of the rechargeable battery and achieve a higher energy density, but also avert the problems of corrosion of chloride ions and frequent reduction of nitrate ions.

2. Compared with the lithium battery on the current market, said rechargeable battery in the present invention uses low-cost materials, and therefore has better economic benefits.

### BRIEF DESCRIPTION OF THE DRAWINGS

FIG. 1 is a performance comparison graph of the battery obtained in Embodiment 1 and Comparative Example 1 in the present invention.

FIG. 2 is a performance comparison graph of the battery obtained in Embodiment 2 and Comparative Example 2 in the present invention.

FIG. 3 is a performance comparison graph of the battery obtained in Embodiment 3 and Comparative Example 2 in the present invention.

FIG. 4 is a performance comparison graph of the battery obtained in Embodiment 4 and Comparative Example 2 in the present invention.

FIG. 5 is a performance comparison graph of the battery obtained in Embodiment 2 and Comparative Example 3 in the present invention.

FIG. 6 is a performance comparison graph of the battery obtained in Embodiment 2, Embodiment 5, Embodiment 6 and Embodiment 7 in the present invention.

In each of the above figures, the X-axis is the number of charge-discharge cycles and the Y-axis is the mass specific capacity in milliamp hours per gram.

### DETAILED DESCRIPTION OFTHE INVENTION

The present invention provides a rechargeable battery.

Rechargeable Battery

A rechargeable battery includes a case, an electrolyte, a positive electrode and a negative electrode provided in the electrolyte and an isolation membrane arranged between the positive electrode and the negative electrode. Said electrolyte, said positive electrode, said negative electrode, and said isolation membrane are all provided in the case.

An active substance of said positive electrode includes one or more of manganese oxide (MnOx, x is acceptable between 0.8˜2.5) and manganese oxyhydroxide. The mass percentage of one or more of manganese oxide and manganese oxyhydroxide in the active substance of said positive electrode may be 33% or more, preferably 45% or more, more preferably 55% or more. The crystal lattice of the manganese oxide or manganese oxyhydroxide may also contain a small amount of other impurity ions, but they are dominantly manganese and oxygen. The number of manganese ions accounts for more than 80% of all cations and the sum of oxygen ions and hydroxide ions accounts for more than 80% of all anions.

In addition, the manganese oxide and manganese oxyhydroxide in the active substance of said positive electrode may exist in the form of a hydrate.

The active substance of the negative electrode contains zinc element, and the mass percentage of zinc in the active substance of said negative electrode may be 33% or more, preferably 45% or more, more preferably 55% or more. The zinc may exist in the form of zinc foil, zinc flakes, zinc powder (the zinc powder is mixed with an adhesive to form a solid as the negative electrode) and zinc alloy.

The electrolyte salt in said electrolyte may further include one or more of zinc alkylsulfonate, zinc arylsulfonate, zinc fluoborate, zinc alkylsulfonate hydrate, zinc arylsulfonate hydrate and zinc fluoroborate hydrate. The concentration of the electrolyte salt in said electrolyte is acceptable between 0.1˜8 mol/L.

The concentration of zinc ions in said electrolyte is between 0.1˜6 mol/L, preferably 1.0˜2.5 mol/L.

The molar percentage of an electrolyte salt containing one or more of sulfonate ions and fluoroborate ions can be 10% or more of the total electrolyte salt, preferably 45% or more, more preferably 55% or more.

The solvent of said electrolyte can be water or a mixture of water and an organic solvent; a gelatinous substance may be added into the electrolyte so that the electrolyte exists in the form of gel.

Said organic solvent can be one or more of an ether organic solvent, an ester organic solvent, a nitrile organic solvent, an amine organic solvent, a sulfone organic solvent, an alcohol organic solvent and an amide organic solvent, such as tetrahydrofuran, propylene carbonate, ethylene carbonate, acetonitrile, dimethyl carbonate, sulfolane, γ-butyrolactone, 2-methyltetrahydrofuran, diethyl carbonate, 3-methylsulfolane, dimethylsulfoxide, dimethoxyethane, ethyl methyl carbonate, N, N-dimethylformamide, diethylethane, etc.

Said zinc alkylsulfonate can be one or more of zinc methanesulfonate, zinc ethylsulfonate and zinc propylsulfonate.

Said zinc arylsulfonate can be one or more of zinc benzenesulfonate and zinc p-toluenesulfonate.

Said zinc alkylsulfonate hydrate can be one or more of zinc methanesulfonate hydrate, zinc ethylsulfonate hydrate and zinc propylsulfonate hydrate.

Said zinc arylsulfonate hydrate can be one or more of zinc benzenesulfonate hydrate or zinc p-toluenesulfonate hydrate.

The electrolyte salt in said electrolyte may further include one or more of manganese alkylsulfonate, manganese arylsulfonate, manganese fluoroborate, manganese alkylsulfonate hydrate, manganese arylsulfonate hydrate and manganese fluoroborate hydrate.

Said manganese alkylsulfonate can be one or more of manganese methanesulfonate, manganese ethylsulfonate and manganese propylsulfonate. Said manganese arylsulfonate can be one or more of manganese benzenesulfonate and manganese p-toluenesulfonate. Said manganese alkylsulfonate hydrate can be one or more of manganese methanesulfonate hydrate, manganese ethylsulfonate hydrate and manganese propylsulfonate hydrate. Said manganese arylsulfonate hydrate can be one or more of manganese benzenesulfonate hydrate and manganese p-toluenesulfonate hydrate.

The electrolyte salt may further include one or more of zinc sulfate, manganese sulfate, zinc chloride, manganese chloride, zinc nitrate, manganese nitrate, zinc acetate, manganese acetate, zinc formate and manganese formate, which do not substantially affect the capacity and circulation stability of the battery.

The hydrogen atoms in said zinc methanesulfonate, zinc ethylsulfonate, zinc propylsulfonate, manganese methanesulfonate, manganese ethylsulfonate, manganese propylsulfonate, zinc benzenesulfonate, zinc p-toluenesulfonate, manganese besylate, manganese p-toluenesulfonate and their hydrates can be substituted by other substituents. The other substituents can specifically be one or more of fluorine atom, chlorine atom, methyl group, ethyl group, n-propyl group, isopropyl group and hydroxide group, which can also achieve the object of the present invention.

The present invention will be further described below in combination with the drawings and the embodiments.

According to the present invention, said rechargeable battery includes a case, an electrolyte, a positive electrode and a negative electrode provided in the electrolyte and an isolation membrane arranged between the positive electrode and the negative electrode. Said electrolyte, said positive electrode, said negative electrode, and said isolation membrane are all provided in the case.

A button battery is used in the rechargeable battery in some embodiments of the present invention, where a zinc foil is selected as a negative electrode, a glass fiber isolation membrane (about 1 mm thick, with an average aperture of 1-10 μm) is used as the isolation membrane and an electrolytic manganese dioxide with a particle size of about 200 nm is used for manganese dioxide in the active substance of the positive electrode.

The circulation stability and energy density of the obtained battery are tested on a LAND battery test system.

The manganese oxyhydroxide in some embodiments of the present invention adopts a self-made method, and the preparation method is: add manganese sulfate (4.53 g) and sulfuric acid solution (2 mL, 0.5 mol/L) into deionized water (90 mL), stir until completely dissolved; then, add potassium permanganate solution (20 mL, 1 mol/L) into the above solution and continue stirring for about 2 hours; after stirring, transfer the obtained mixture into a Teflon-lined hydrothermal kettle and put it into an oven at 120° C. for 12 hours. After the reaction, filter the obtained product for three times with deionized water and finally put it into an oven for drying to obtain manganese oxyhydroxide used in the embodiments.

### COMPARATIVE EXAMPLE 1

### Rechargeable Zinc-Manganese Battery with Electrolyte of Zinc Sulfate Solution

Preparation of the positive electrode: a binder (polyvinylidene fluoride) is firstly dissolved in N-methylpyrrolidone to form a dispersion with a mass fraction of 5%; manganese dioxide, manganese oxyhydroxide, acetylene black and polyvinylidene fluoride are mixed in a mass ratio of 70:5:15:10, stirred evenly in a high-speed mixer; the obtained mixture is uniformly coated on the surface of graphite conductive paper and transferred to a 120° C. vacuum oven; take the product out after 12 hours and cut it to obtain a positive electrode sheet.

Preparation of the electrolyte: zinc sulfate heptahydrate (57.5 g) is dissolved in deionized water (100 mL) to prepare a zinc sulfate solution (approximately 1.6 mol/L) as the electrolyte.

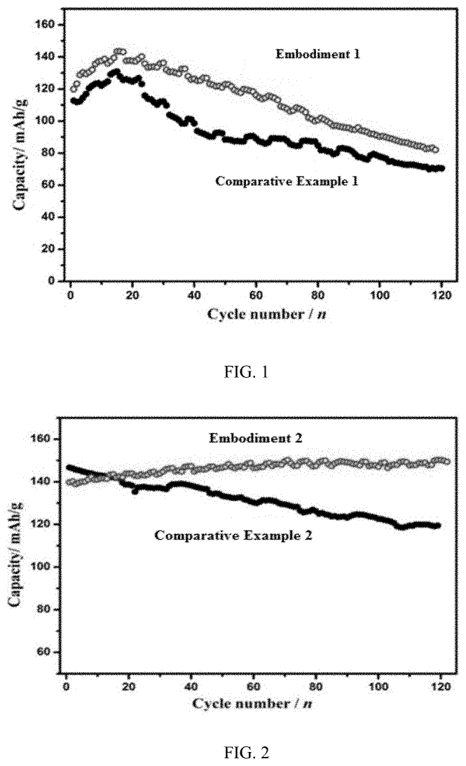

A button battery is made by using the prepared positive electrode sheet as a positive electrode, a zinc foil as a negative electrode, the zinc sulfate solution (1.6 mol/L) as electrolyte the electrolyte and assembling the the glass fiber isolation membrane. The assembled button battery is tested by battery test system; the test current is 300 mA/g and the charge-discharge voltage range is 1.0-1.9 V. The relationship between the number of charge-discharge cycles and the mass specific capacity of the battery is presented in FIG.1.

### COMPARATIVE EXAMPLE 2

### Rechargeable Zinc-Manganese Battery with Electrolyte of Zinc Sulfate and Manganese Sulfate

Preparation of the positive electrode: the binder (polyvinylidene fluoride) is firstly dissolved in N-methylpyrrolidone to form a dispersion with a mass fraction of 5%; manganese dioxide, manganese oxyhydroxide, acetylene black and polyvinylidene fluoride are mixed in a mass ratio of 70:5:15:10, stirred evenly in a high-speed mixer; the obtained mixture is uniformly coated on the surface of graphite conductive paper, transferred to a 120° C. vacuum oven; take the product out after 12 hours, and cut it to obtain a positive electrode sheet.

Preparation of the electrolyte: zinc sulfate heptahydrate (57.5 g) and manganese sulfate monohydrate (3.38 g) are dissolved in deionized water (100 mL) to prepare to an electrolyte with zinc sulfate (approximately 1.6 mol/L) and manganese sulfate (approximately 0.16 mol/L).

A button battery is made by using the prepared positive electrode sheet as a positive electrode, a zinc foil as a negative electrode, the aqueous solution with zinc sulfate (approximately 1.6 mol/L) and manganese sulfate (approximately 0.16 mol/L) as the electrolyte and assembling the glass fiber isolation membrane.

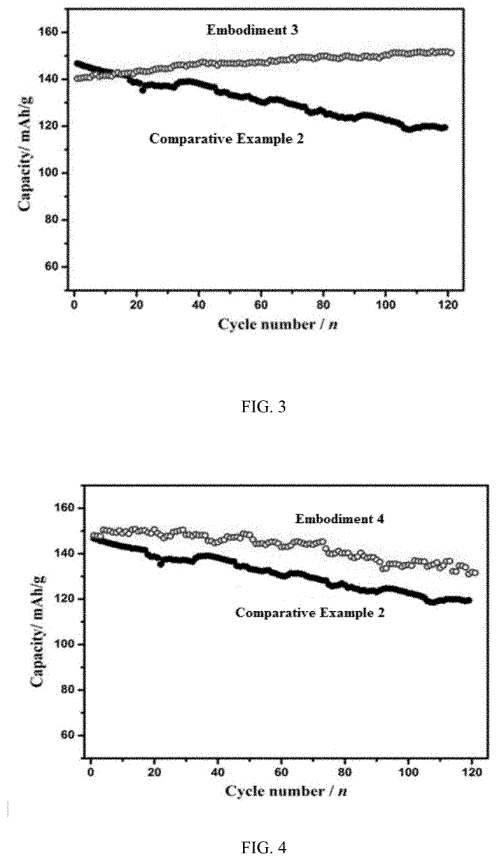

The assembled button battery is tested by battery test system; the test current is 300 mA/g and the charge-discharge voltage range is 1.0-1.9 V. FIG.2 and FIG. 3˜5 present the relationship curve between the number of charge-discharge cycles and the mass specific capacity of the battery.

### COMPARATIVE EXAMPLE 3

### Rechargeable Hybrid Water-Based Lithium-Zinc Battery with Electrolyte of Zinc Methanesulfonate and Lithium Methanesulfonate Aqueous Solution

Preparation of the positive electrode: binder (polyvinylidene fluoride) is firstly dissolved in N-methylpyrrolidone to form a dispersion with a mass fraction of 5%; lithium manganate, acetylene black and polyvinylidene fluoride are mixed in a mass ratio of 75:15:10, stirred evenly in a high-speed mixer; the mixture is uniformly coated on the surface of graphite conductive paper and transferred to a 120° C. vacuum oven; take the product out after 12 hours, and cut it to obtain a positive electrode sheet.

Preparation of the electrolyte, zinc methanesulfonate (51.1 g) and lithium methanesulfonate (10.2 g) are dissolved in deionized water (100 mL) to prepare to an electrolyte with zinc methanesulfonate (approximately 1.6 mol/L) and lithium methanesulfonate (approximately 0.8 mol/L).

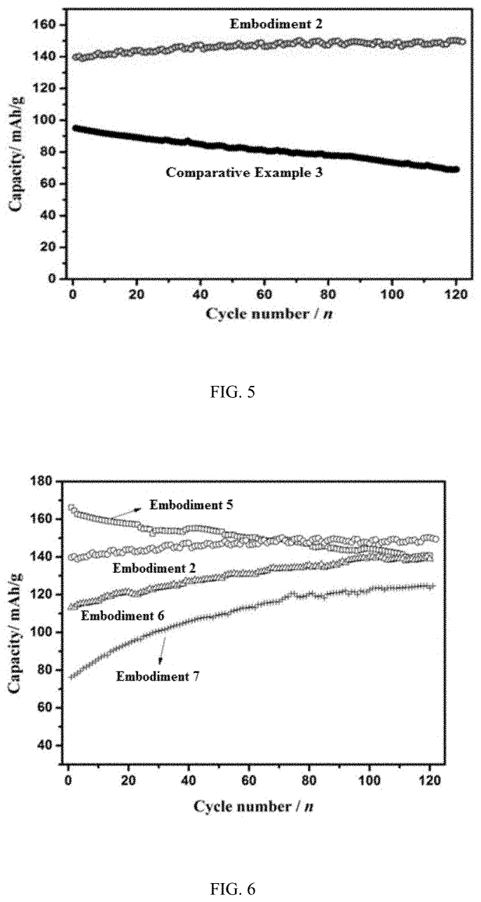

A button battery is made by using the prepared positive electrode sheet as a positive electrode, a zinc foil as a negative electrode, the aqueous solution with zinc methanesulfonate (approximately 1.6 mol/L) and lithium methanesulfonate (approximately 0.8 mol/L) as the electrolyte and assembling a glass fiber isolation memebrane. The assembled button battery is tested by battery test system; the tested current is 300 mA/g and the charge-discharge voltage range is 1.4-2.1 V. The relationship between the number of charge-discharge cycles and the mass specific capacity of the battery is presented in FIG.5.

The energy density of the battery is tested and the results show that the energy density of the system is 160 Wh/kg (based on the mass of the active substance of the positive electrode and only the active substance of the positive electrode is calculated).

Embodiment 1

Preparation of the positive electrode: the binder (polyvinylidene fluoride) is firstly dissolved in N-methylpyrrolidone to form a dispersion with a mass fraction of 5%; manganese dioxide, manganese oxyhydroxide, acetylene black and polyvinylidene fluoride are mixed in a mass ratio of 70:5:15:10, stirred evenly in a high-speed mixer; the mixture is uniformly coated on the surface of graphite conductive paper and transferred to a 120° C. vacuum oven; take the product out after 12 hours and cut it to obtain a positive electrode sheet.

Preparation of the electrolyte: zinc methanesulfonate (51.1 g) is dissolved in deionized water (100 mL) to prepare an electrolyte with zinc methanesulfonate solution (approximately 1.6 mol/L).

The rechargeable battery described in this embodiment is a button battery obtained by using the prepared positive electrode sheet as a positive electrode, a zinc foil as a negative electrode, the zinc methanesulfonate aqueous solution (approximately 1.6 mol/L) as the electrolyte and assembling a glass fiber isolation membrane.

The assembled button battery is tested by battery test system; the test current is 300 mA/g and the charge-discharge voltage range is 1.0-1.9 V; the relationship between the number of charge-discharge cycles and the mass specific capacity of the battery is presented in FIG.1 (this embodiment is compared with Comparative Example 1). FIG.1 shows that the circulation stability of the rechargeable zinc-manganese battery can be significantly improved by using zinc methanesulfonate instead of zinc sulfate as the electrolyte salt of the rechargeable zinc-manganese battery.

Embodiment 2

Preparation of the positive electrode: the binder (polyvinylidene fluoride) is firstly dissolved in N-methylpyrrolidone to form a dispersion with a mass fraction of 5%; manganese dioxide, manganese oxyhydroxide, acetylene black and polyvinylidene fluoride are mixed in a mass ratio of 70:5:15:10, stirred evenly in a high-speed mixer; the mixture is uniformly coated on the surface of graphite conductive paper and transferred to a 120° C. vacuum oven; take the product out after 12 hours, and cut it to obtain a positive electrode sheet.

Preparation of the electrolyte: zinc methanesulfonate (51.1 g) and manganese methanesulfonate (4.9 g) are dissolved in deionized water (100 mL) to form an electrolyte with zinc methanesulfonate (approximately 1.6 mol/L) and manganese methanesulfonate (approximately 0.16 mol/L).

The rechargeable battery described in this embodiment is a button battery by using the prepared positive electrode sheet as a positive electrode, a zinc foil as a negative electrode, the aqueous solution with zinc methanesulfonate (approximately 1.6 mol/L) and manganese methanesulfonate (approximately 0.16 mol/L) as the electrolyte and assembling a glass fiber isolation membrane. The assembled button battery is tested by battery test system; the test current is 300 mA/g and the charge-discharge voltage range is 1.0-1.9 V; the relationship between the number of charge-discharge cycles and the mass specific capacity of the battery is presented in FIG. 2 (this embodiment is compared with Comparative Example 2) and FIG.5 (this embodiment is compared with Comparative Example 3). FIG. 2 shows that the circulation stability of the rechargeable zinc-manganese battery can be significantly improved by using zinc methanesulfonate and manganese methanesulfonate (the electrolyte salt used in this embodiment) instead of zinc sulfate and manganese sulfate (the electrolyte salt used in Comparative Example 2) as the electrolyte salt of the rechargeable zinc-manganese battery.

FIG. 5 shows that the circulation stability and mass specific capacity of the rechargeable zinc-manganese battery are significantly better than those of the rechargeable mixed water-based lithium-zinc battery obtained in Comparative Example 3 even though both use methanesulfonate as the electrolyte salt.

The energy density of the battery obtained in this embodiment is tested and the results show that the energy density of the system is 195 Wh/kg (based on the mass of the active substance of the positive electrode), which is also significantly higher than the energy density (160 Wh/kg) of the rechargeable mixed water-based lithium-zinc battery obtained in Comparative Example 3.

Embodiment 3

Preparation of the positive electrode: the binder (polyvinylidene fluoride) is firstly dissolved in N-methylpyrrolidone to form a dispersion with a mass fraction of 5%; manganese dioxide, manganese oxyhydroxide, acetylene black and polyvinylidene fluoride are mixed in a mass ratio of 70:5:15:10, stirred evenly in a high-speed mixer; the mixture is uniformly coated on the surface of graphite conductive paper and transferred to a 120° C. vacuum oven; take the product out after 12 hours and cut it to obtain a positive electrode sheet.

Preparation of the electrolyte, zinc methanesulfonate (51.1 g) and manganese fluoroborate (4.57 g) are dissolved in deionized water (100 mL) to prepare an electrolyte with zinc methanesulfonate (approximately 1.6 mol/L) and manganese fluoroborate (approximately 0.16 mol/L).

The rechargeable battery described in this embodiment is obtained by using the prepared positive electrode sheet as a positive electrode, a zinc foil as a negative electrode, the aqueous solution with zinc methanesulfonate (approximately 1.6 mol/L) and manganese fluoroborate (approximately 0.16 mol/L) as the electrolyte and assembling a glass fiber isolation membrane.

The assembled button battery is tested by battery test system; the test current is 300 mA/g, the charge-discharge voltage range is 1.0-1.9 V, the relationship between the number of charge-discharge cycles and the mass specific capacity of the battery is presented in FIG. 3 (this embodiment is compared with Comparative Example 2). FIG. 3 shows that the circulation stability of the rechargeable zinc-manganese battery can be significantly improved by using zinc methanesulfonate and manganese fluoroborate instead of zinc sulfate and manganese sulfate as the electrolyte salt of the rechargeable zinc-manganese battery.

Embodiment 4

Preparation of the positive electrode: the binder (polyvinylidene fluoride) is firstly dissolved in N-methylpyrrolidone to form a dispersion with a mass fraction of 5%; manganese dioxide, manganese oxyhydroxide, acetylene black and polyvinylidene fluoride are mixed in a mass ratio of 70:5:15:10, stirred evenly in a high-speed mixer, and the mixture is uniformly coated on the surface of graphite conductive paper and transferred to a 120° C. vacuum oven; take the product out after 12 hours, and cut it to obtain a positive electrode sheet.

Preparation of the electrolyte, zinc methanesulfonate (51.1 g) and manganese sulfate monohydrate (3.38 g) are dissolved in deionized water (100 mL) to prepare an electrolyte with zinc methanesulfonate solution (approximately 1.6 mol/L) and manganese sulfate monohydrate (approximately 0.16 mol/L).

The rechargeable battery described in this embodiment is a button battery obtained by using the prepared positive electrode sheet as a positive electrode, a zinc foil as a negative electrode, the aqueous solution with zinc methanesulfonate (approximately 1.6 mol/L) and manganese sulfate monohydrate (approximately 0.16 mol/L) as the electrolyte and assembling a glass fiber isolation membrane.

The assembled button battery is tested by battery test system; the test current is 300 mA/g and the charge-discharge voltage range is 1.0-1.9 V; the relationship between the number of charge-discharge cycles and the mass specific capacity of the battery is presented in FIG. 4 (this embodiment is compared with Comparative Example 2). FIG. 4 shows that the circulation stability of the rechargeable zinc-manganese battery can be significantly improved by using zinc methanesulfonate instead of zinc sulfate as the electrolyte salt of the rechargeable zinc-manganese battery when the electrolyte contains manganese sulfate.

Embodiment 5

Preparation of the positive electrode: the binder (polyvinylidene fluoride) is firstly dissolved in N-methylpyrrolidone to form a dispersion with a mass fraction of 5%; manganese dioxide, manganese oxyhydroxide, acetylene black and polyvinylidene fluoride are mixed in a mass ratio of 70:5:15:10, stirred evenly in a high-speed mixer, and the mixture is uniformly coated on the surface of graphite conductive paper and transferred to a 120° C. vacuum oven; take it out after 12 hours and cut it to obtain a positive electrode sheet.

Preparation of the electrolyte: zinc methanesulfonate (12.88 g) and manganese methanesulfonate (4.9 g) are dissolved in deionized water (100 mL) to prepare an electrolyte with zinc methanesulfonate (approximately 0.47 mol/L) and manganese methanesulfonate (approximately 0.16 mol/L).

The rechargeable battery described in this embodiment is a button battery obtained by using the prepared positive electrode sheet as a positive electrode, a zinc foil as a negative electrode, the aqueous solution with zinc methanesulfonate (approximately 0.47 mol/L) and concentration of manganese methanesulfonate (approximately 0.16 mol/L) as the electrolyte and assembling with a glass fiber isolation membrane.

The assembled button battery is tested by battery test system; the test current is 300 mA/g and the charge-discharge voltage range is 1.0-1.9 V. The relationship between the number of charge-discharge cycles and the mass specific capacity of the battery is presented in FIG.6.

Embodiment 6

Preparation of the positive electrode: the binder (polyvinylidene fluoride) is firstly dissolved in N-methylpyrrolidone to form a dispersion with a mass fraction of 5%; manganese dioxide, manganese oxyhydroxide, acetylene black and polyvinylidene fluoride are mixed in a mass ratio of 70:5:15:10, stirred evenly in a high-speed mixer; the mixture is uniformly coated on the surface of graphite conductive paper and transferred to a 120° C. vacuum oven; take the product out after 12 hours and cut it to obtain a positive electrode sheet.

Preparation of the electrolyte: zinc methanesulfonate (90.12 g) and manganese methanesulfonate (4.9 g) are dissolved in deionized water (100 mL) to prepare an electrolyte with zinc methanesulfonate (approximately 2.5 mol/L) and manganese methanesulfonate (approximately 0.16 mol/L).

The rechargeable battery described in this embodiment is a button battery by using the prepared positive electrode sheet as a positive electrode, a zinc foil as a negative electrode, the aqueous solution with zinc methanesulfonate (approximately 2.5 mol/L) and manganese methanesulfonate (approximately 0.16 mol/L) as the electrolyte and assembling with a glass fiber isolation membrane.

The assembled button battery is tested by battery test system; the test current is 300 mA/g and the charge-discharge voltage range is 1.0-1.9 V. The relationship between the number of charge-discharge cycles and the mass specific capacity of the battery is presented in FIG.6.

Embodiment 7

Preparation of the positive electrode: the binder (polyvinylidene fluoride) is firstly dissolved in N-methylpyrrolidone to form a dispersion with a mass fraction of 5%; manganese dioxide, manganese oxyhydroxide, acetylene black and polyvinylidene fluoride are mixed in a mass ratio of 70:5:15:10, stirred evenly in a high-speed mixer; the mixture is uniformly coated on the surface of graphite conductive paper and transferred to a 120° C. vacuum oven; take it out after 12 hours, and cut it to obtain a positive electrode sheet.

Preparation of the electrolyte: zinc methanesulfonate (128.75 g) and manganese methanesulfonate (4.9 g) are dissolved in deionized water (100 mL) to prepare an electrolyte with zinc methanesulfonate (approximately 3.1 mol/L) and manganese methanesulfonate (approximately 0.16 mol/L).

The rechargeable battery described in this embodiment is a button battery by using the prepared positive electrode sheet as a positive electrode, a zinc foil as a negative electrode, the aqueous solution with zinc methanesulfonate (approximately 3.1 mol/L) and manganese methanesulfonate (approximately 0.16 mol/L) as the electrolyte, assembling a glass fiber isolation membrane.

The assembled button battery is tested by battery test system; the test current is 300 mA/g and the charge-discharge voltage range is 1.0-1.9 V. The relationship between the number of charge-discharge cycles and the mass specific capacity of the battery is presented in FIG.6.

As shown in FIG.6, when the concentration of zinc ions in the electrolyte is low (e.g. 0.5 mol/L), the rechargeable zinc-manganese battery will release a higher capacity, but the circulation stability is poor. With the increase of the concentration of zinc ions, the reversible capacity of rechargeable zinc-manganese batteries is slightly reduced, but the circulation stability is improved. Taking these factors into consideration, a suitable concentration of zinc ions in the electrolyte is 0.1 mol/L˜6 mol/L, preferably 1.0 mol/L˜2.5 mol/L.

The foregoing description of the embodiments is for the convenience of those skilled in the art to understand and apply the present invention. It is obvious that those skilled in the art can easily make various modifications to these embodiments and apply the general principles described herein to other embodiments without creative work. Therefore, the present invention is not limited to the embodiments herein, and the improvements and modifications made by those skilled in the art according to the disclosure of the invention and without departing from the scope of the present invention should be within the protection scope of the present invention.

1. A rechargeable battery comprising an electrolyte, a positive electrode, a negative electrode, an isolation membrane arranged between the positive electrode and the negative electrode, an active substance of said positive electrode comprising one or more of manganese oxide and manganese oxyhydroxide and an active substance of said negative electrode comprising zinc, wherein electrolyte salts in said electrolyte comprise one or more of zinc alkylsulfonate, zinc arylsulfonate, zinc fluoroborate, zinc alkylsulfonate hydrate, zinc arylsulfonate hydrate and zinc fluoroborate hydrate.

2. The rechargeable battery of claim 1, wherein the concentration of the electrolyte salts in said electrolyte is 0.1˜8 mol/L; and/or,
the molar percentage of an electrolyte salt containing one or more of sulfonate ions and fluoroborate ions is 5% or more of the total electrolyte salts.

3. The rechargeable battery of claim 1, wherein the concentration of zinc ions in said electrolyte is 0.1-6 mol/L; and/or, said zinc alkylsulfonate is one or more of zinc methanesulfonate, zinc ethylsulfonate and zinc propylsulfonate; and/or,
said zinc arylsulfonate is one or more of zinc benzenesulfonate and zinc p-toluenesulfonate; and/or,
said zinc alkylsulfonate hydrate is one or more of zinc methylsulfonate hydrate, zinc ethylsulfonate hydrate and zinc propylsulfonate hydrate; and/or,
said zinc arylsulfonate hydrate is one or more of zinc benzenesulfonate hydrate and zinc p-toluenesulfonate hydrate.

4. The rechargeable battery of claim 1, wherein the electrolyte salt in said electrolyte further comprises one or more of manganese alkylsulfonate, manganese arylsulfonate, manganese fluoroborate, manganese alkylsulfonate hydrate, manganese arylsulfonate hydrate and manganese fluoroborate hydrate.

5. The rechargeable battery of claim 4, wherein said manganese alkylsulfonate is one or more of manganese methanesulfonate, manganese ethylsulfonate and manganese propylsulfonate; and/or,
said manganese arylsulfonate is one or more of manganese benzenesulfonate and manganese p-toluenesulfonate; and/or,
said manganese alkylsulfonate hydrate is one or more of manganese methanesulfonate hydrate, manganese ethylsulfonate hydrate and manganese propylsulfonate hydrate; and/or,
said manganese arylsulfonate hydrate is one or more of manganese benzenesulfonate hydrate and manganese p-toluenesulfonate hydrate.

6. The rechargeable battery of claim 1, wherein the mass percentage of one or more of manganese oxide and manganese oxyhydroxide in the active substance of said positive electrode is 20% or more.

7. The rechargeable battery of claim 1, wherein the mass percentage of zinc in the active substance of said negative electrode is 33% or more.

8. The rechargeable battery of claim 1, wherein a solvent of said electrolyte is water or a mixture of water and an organic solvent.

9. The rechargeable battery of claim 1, wherein the electrolyte salt further comprises one or more of zinc sulfate, manganese sulfate, zinc chloride, manganese chloride, zinc nitrate, manganese nitrate, zinc acetate, manganese acetate, zinc formate and manganese formate.

10. The rechargeable battery of claim 1, wherein said rechargeable battery further comprises a case, wherein said positive electrode, said negative electrode, said isolation membrane and said electrolyte are all arranged in the case.

11. The rechargeable battery of claim 1, wherein the concentration of zinc ions in said electrolyte is 1.0˜2.5 mol/L.
